(19) United States
(12) Patent Application Publication
(10) Pub. No.: US 2019/0384490 A1
(43) Pub. Date: Dec. 19, 2019

(54) CONTEXTUAL AWARENESS SYSTEM

(71) Applicant: HONEYWELL INTERNATIONAL INC., Morris Plains, NJ (US)

(72) Inventors: Katarina Alexis Morowsky, Phoenix, AZ (US); Ivan Sandy Wyatt, Scottsdale, AZ (US); Vincent Vu, Peoria, AZ (US); Aaron Gannon, Anthem, AZ (US)

(73) Assignee: HONEYWELL INTERNATIONAL INC., Morris Plains, NJ (US)

(21) Appl. No.: 16/400,930

(22) Filed: May 1, 2019

Related U.S. Application Data
(60) Provisional application No. 62/685,444, filed on Jun. 15, 2018.

(51) Int. Cl. G06F 3/0488; B64D 43/00; G06F 3/0485; G06F 3/0484

(52) U.S. Cl. CPC G06F 3/04886; B64D 43/00; G06F 2203/04808; G06F 3/04842; G06F 3/0485

(57) ABSTRACT

A contextual awareness system for an aircraft and a method from controlling the same are provided. The aircraft, for example, may include, but is not limited to, a touch screen display, a memory configured to store rules defining a relationship between a plurality of data fields, and a processor configured to determine when a data field displayed on the touch screen display is selected, determine at least one data field which is related to the selected data field based upon the rules defining the relationship between a plurality of data fields, generate display data for the touch screen display, the display data comprising a virtual keyboard and a contextual awareness display area, the contextual awareness display area displaying the selected field and the at least one data field which is related to the selected data, and update the selected data field based upon input from the virtual keyboard.

### CLAIM OF PRIORITY

The present application claims benefit of prior filed U.S. Provisional Patent Application 62/685,444, filed Jun. 15, 2018, which is hereby incorporated by reference herein in its entirety.

### TECHNICAL FIELD

The present disclosure generally relates to an aircraft, and more particularly relates to systems and methods for an aircraft display and control system.

### BACKGROUND

Aircraft are often fitted or retrofitted with touchscreen displays to provide an easy way to interact with various systems of the aircraft. The touchscreen displays, particularly in older aircraft which are being retrofitted with the touchscreen displays, are often limited in size, which limits the amount of data visible on a screen. When an input device, such as a virtual keyboard, is displayed on the touchscreen, even less space is available for other data on the touchscreen display. Accordingly, the size limitation for the touchscreen displays can make it difficult to effectively interact with the touchscreen display.

### BRIEF SUMMARY

In one embodiment, for example, an aircraft is provided. The aircraft may include, but is not limited to, a touch screen display, a memory configured to store rules defining a relationship between a plurality of data fields, and a processor communicatively coupled to the touch screen display and the memory, the processor configured to determine when a data field displayed on the touch screen display is selected by a user, determine at least one data field which is related to the selected data field based upon the rules defining the relationship between a plurality of data fields stored in the memory, generate display data for the touch screen display, the display data comprising a virtual keyboard and a contextual awareness display area, the contextual awareness display area displaying the selected field and the at least one data field which is related to the selected data, and update the selected data field based upon input from the virtual keyboard.

In an embodiment, for example, a method of operating a contextual awareness system for an aircraft is provided. The method may include, but is not limited to, generating, by a processor, contextual awareness display data for the contextual awareness system and outputting the contextual awareness display data to a touch screen display, the contextual awareness display data comprising a plurality of data fields, receiving, by the processor, input selecting one of the plurality of data fields from the touch screen display, determining, by the processor, at least one related data field to the selected one of the plurality of data fields based upon a chunking rule associated with the selected one of the plurality of data fields, generating, by the processor, updated contextual awareness display data for the contextual awareness system and outputting the updated contextual awareness display data to the touch screen display, the updated contextual awareness display data comprising a virtual keyboard and a contextual awareness display area, the contextual awareness display area displaying the selected one of the plurality of data fields and the at least related data field to the selected one of the plurality of data field, and updating the selected data field based upon input to the virtual keyboard.

### BRIEF DESCRIPTION OF THE DRAWINGS

The detailed description will hereinafter be described in conjunction with the following drawing figures, wherein like numerals denote like elements, and wherein:

FIG. 1 is a block diagram of an aircraft, in accordance with an embodiment;

FIG. 2 illustrates an exemplary touch screen display in accordance with an embodiment;

FIG. 3 illustrates another exemplary touch screen display in accordance with an embodiment;

FIG. 4 illustrates yet another exemplary touch screen display, in accordance with an embodiment;

FIG. 5 illustrates another exemplary touch screen display, in accordance with an embodiment;

FIG. 6 illustrates yet another exemplary touch screen display, in accordance with an embodiment;

FIG. 7 illustrates another exemplary touch screen display, in accordance with an embodiment;

FIG. 8 illustrates yet another exemplary touch screen display, in accordance with an embodiment;

FIG. 9 illustrates another exemplary touch screen display in accordance with an embodiment; and

FIG. 10 is a flow diagram illustrating an exemplary method for operating the contextual awareness system, in accordance with an embodiment.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

In accordance with an embodiment, a contextual awareness system for an aircraft is provided. As discussed in further detail below, the contextual awareness system identifies and displays data fields which are related to a selected data field, thereby providing contextual awareness for a user for the selected data field, as discussed in further detail below.

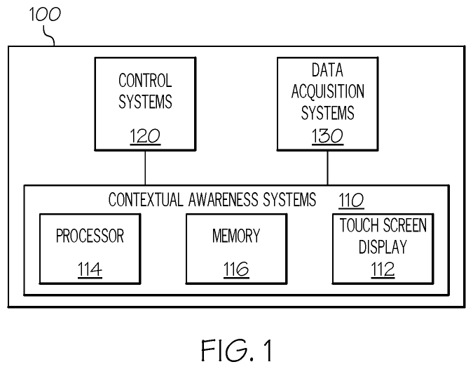

FIG. 1 is a block diagram of an aircraft 100 in accordance with an embodiment. The aircraft 100 may be an airplane, a helicopter, a spacecraft, or the like. The aircraft 100 includes a contextual awareness system 110. The contextual awareness system 110 includes a touch screen display 112 which, as discussed in further detail below, provides contextual awareness when a user (e.g., the pilot, co-pilot or other crew member) is entering data into the system. In one embodiment, for example, the contextual awareness system 110 may be implemented as a flight management system (FMS) where a user is provided more contextual awareness when entering data into the FMS. However, a variety of systems may be implemented using the contextual awareness system 110 including, for example, a synoptic system or any other system in the aircraft where a user enters data. While FIG. 1 illustrates an aircraft, any other vehicle or system which receives user input may utilize the contextual awareness system 110.

The contextual awareness system 110 includes at least one processor 114. The processor 114 may be, for example, a central processing unit (CPU), a physics processing unit (PPU), a graphics processing unit (GPU), a field programmable gate array (FPGA), an application specific integrated circuit (ASIC), a microcontroller, or any other logic unit or combination thereof. While the processor 114 is illustrated as being part of the contextual awareness system 110, the processor 114 may be shared by one or more other systems in the aircraft 100.

The contextual awareness system 110 further includes a memory 116. The memory 116 may be any combination of volatile and non-volatile memory. The memory 116 may store non-transitory computer readable instructions for operating the contextual awareness system 110, as discussed in further detail below. While FIG. 1 illustrates the memory 116 as being within the aircraft 100, some or all of the memory 116 may be a cloud-based memory which is accessed via a communications system (not illustrated).

The memory 116 further stores a chunking database defining rules for chunking data fields. Chunking, as used in this context, refers to data fields which may be related to one-another for a variety of reasons. As discussed in further detail below, a data field that a user has selected to update may be related to other data fields. The rules associated with the data field the user is operating upon define how related data fields are presented to the user to give contextual awareness to the user when entering data into the selected data field.

The aircraft 100 further includes at least one control system 120 communicatively connected to the contextual awareness system 110 via any wired or wireless communication system. The control system 120 may be, for example, an engine, a brake, a vertical stabilizer, a flap, landing gear, automatic flight control system, autopilot, autothrottle, autobrakes or any other control system of the aircraft 100 or any combination thereof. The control system 120, based upon input from the contextual awareness system 110 may control the aircraft 100 based upon input from the contextual awareness system 110. For example, movement of the aircraft 100 may be controlled based upon user input to the contextual awareness system 110.

The aircraft 100 further includes at least one data acquisition system 130. The data acquisition system 130 may include, for example, a radio to receive data from air traffic control, sensors to determine data about the aircraft (e.g., air speed sensors, altitude sensor, or the like), or any other data generation or receiving system, or any combination thereof. The data from the data acquisition system may be used to automatically populate one or more data fields presented on the touch screen display 112.

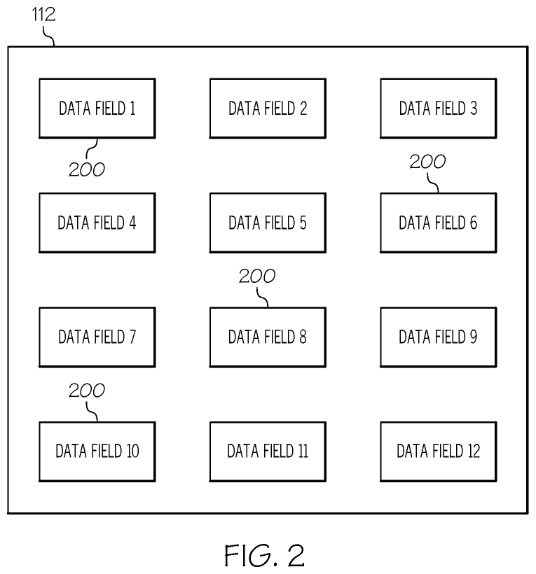

FIG. 2 illustrates an exemplary touch screen display 112 in accordance with an embodiment. As seen in FIG. 2, the exemplary touch screen display 112 includes twelve data fields 200. However, the number of data fields and their arrangement can vary. When a user selects one of the data fields, a user input interface is generated and displayed on the touch screen display. Typically, in order to provide enough area for a touch input, the touch input area will be at least 0.5 inches by 0.5 inches to provide enough room for a user to effectively provide touch input. Accordingly, when providing the user with user input interface, such as a virtual keyboard, the user input interface typically overtakes the majority of the display, thereby causing the user to lose contextual awareness when entering data into a field. In other words, the user input interface covers up other data fields (i.e., non-selected data fields) which may be related to the selected data field and provide context for the selected data field.

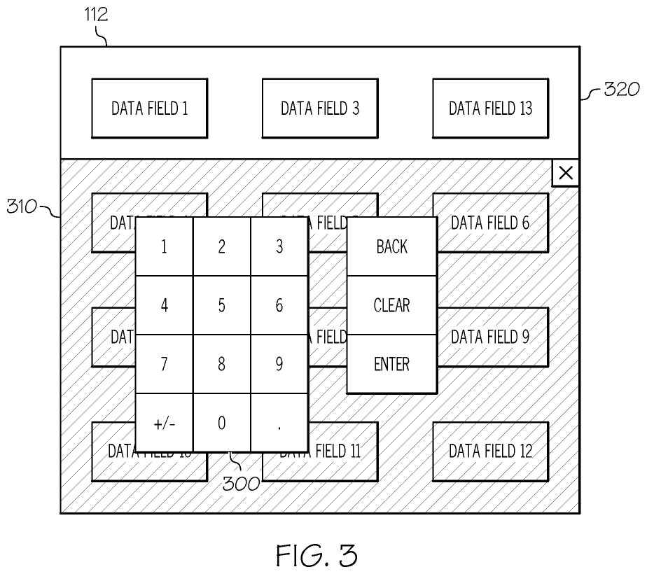

FIG. 3 illustrates an exemplary touch screen display 112 in accordance with an embodiment. In FIG. 3, a user has selected data field 1 from the display illustrated in FIG. 2 as is indicated by the highlight around data field 1. While the highlighting in FIG. 3 is a bold outline, the highlighting could include one or more of a color change, a border change, a lighting change, or any combination thereof.

As seen in FIG. 3, a user input interface 300 is generated and displayed on the touch screen display 112 when a data field has been selected. In this exemplary embodiment, the user input interface 300 is a numeric input interface. However, the user input interface 300 may be any numeric, alphanumeric or letter-based input interface arranged in any format. The type of user input interface 300 which is generated may vary depending upon input associated with the data field. For example, if a data field is a destination airport, a QWERTY keyboard, or the like, may be generated and displayed by the processor 114. As another example, if the data field is a runway which requires both letters and numbers, an alphanumeric keyboard may be generated and displayed by the processor 114.

As seen in FIG. 3, the user input interface 300 covers a portion 310 of the touch screen display 112. In the embodiment illustrated in FIG. 3, the background of the portion 310 of the touch screen display 112 is semi-transparent such that the data fields below the user input interface 300 are partially visible. By having a semi-transparent background, the contextual awareness system 110 gives a user contextual awareness as to what display the user is looking at as well as contextual awareness as to where they are on the display relative to other data fields that are within the portion 310 of the touch screen display 112. However, the background of the portion 310 of the touch screen display which includes the user input interface 300 could also be translucent (i.e., a solid background color) which covers the non-related data fields.

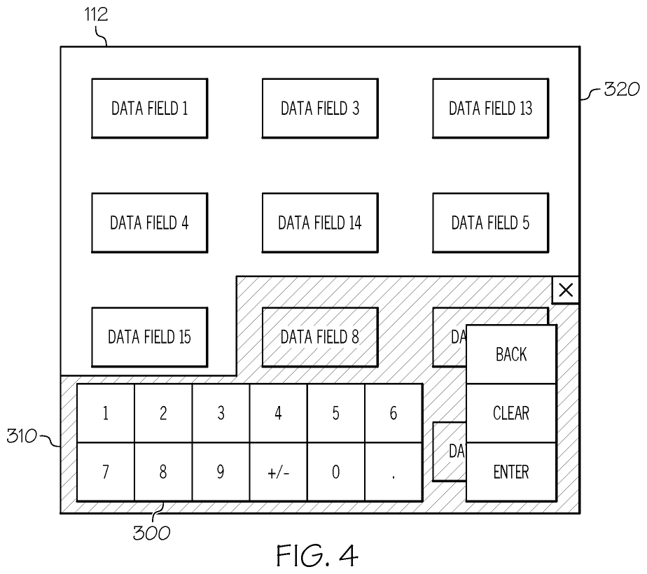

The exemplary touch screen display 112 further includes a contextual awareness display area 320. The contextual awareness display area 320 includes the selected data field, in this example data field 1, as well as other data fields which are related to the selected data field. In the embodiment illustrated in FIG. 3, there are three data fields which are related. However, any number of data fields may be related based on the chunking rules, as discussed in further detail below. The processor 114 may adjust the size of the contextual awareness display area 320, and thus the size of the portion 310 of the touch screen display 112, to reflect the number of related fields. For example, FIG. 4 illustrates an exemplary touch screen display 112, in accordance with an embodiment, in which there are seven related data fields. As seen in FIG. 4, the size of the contextual awareness display area 320 has increased, while the size of the portion 310 of the touch screen display 112 has decreased. As illustrated in FIG. 4, when the size of the contextual awareness display area 320 increases, the format of the user input interface 300 may change to fit within the portion 310 of the touch screen display 112 while maintaining the minimum size requirements for the input fields.

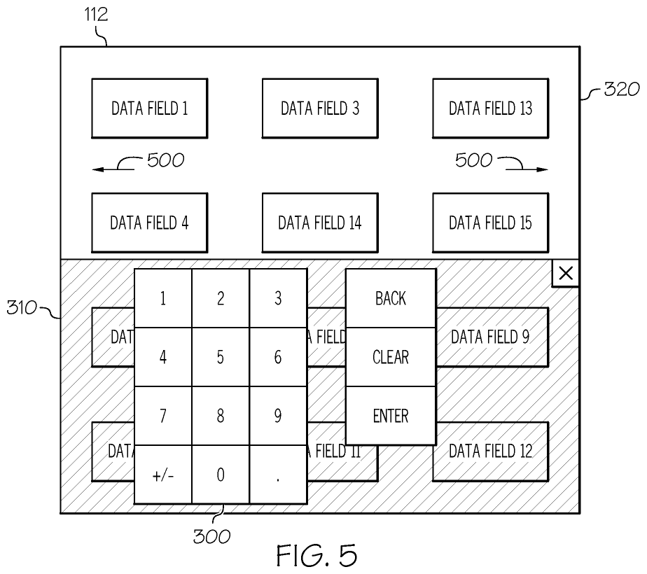

When there is not enough screen space on the touch screen display 112 to display all of the data fields related to the selected data field, while maintaining a large enough area for the user input interface 300, the processor 114 may cause the related data fields to scroll within the contextual awareness display area 320 or otherwise provide controls (e.g., an arrow) which allow a user to scroll between the related data fields such that the user can maintain contextual awareness of all of the related data fields. FIG. 5 illustrates an exemplary touch screen display 112, in accordance with an embodiment. As seen in FIG. 5, arrows 500 are placed on the sides of the touch screen display 112. When a user touches the arrows, the non-selected but related data fields may scroll in the corresponding direction to display other related data fields which could not otherwise fit within the contextual awareness display area 320. The processor 114 may generate the controls and/or automatically scroll through the related data fields when the number of related data fields exceeds a predetermined threshold. The predetermined threshold may vary depending upon, for example, the size of the touch screen display 112, the type of virtual keyboard that is generated, user preferences, or the like, or any combination thereof.

As discussed above, the memory 116 may store chunking rules which define a relationship between the data fields. While the data fields which are related may also be visually neighboring on the default view of touch screen display 112 (i.e., the display illustrated in FIG. 2), the related data fields may be anywhere within the display, may be displayed on another display or even not currently being displayed on the touch screen display 112 prior to receiving user input. For example, as seen in FIG. 5, data fields 13-15 are illustrated as being related to data field 1, even though the data fields 13-15 are not present on the default view of the touch screen display 112. While the touch screen display 112 preferably organizes related data fields close to each other, the size of the touch screen display 112 limits the amount of data that can be effectively displayed at the same time. Furthermore, data which may be related to an important data field may not be as important as other non-related data fields. In other words, the touch screen display 112 preferably displays the most important data fields to a user when in a non-input configuration (e.g., FIG. 2). Accordingly, by displaying the related data fields to a selected data field during user input, the contextual awareness system provides additional contextual awareness to the user, improving the effectiveness of user input to the system, saving the user time (e.g., by not having to flip back and forth between multiple screens to see all of the related data fields), and reducing user error.

The chunking rules stored in the memory 116 may relate data fields for a variety of different reasons. In one embodiment, for example, data fields may be chunked together for the purpose of conceptualizing a concept. For example, a pilot may need to conceptualize wind direction and wind speed as a single thing. As another example, a pilot may need to conceptualize density altitude as a single thing, which is composed of a barometric setting, pressure altitude and outside air temperature. Accordingly, as visually indicated in FIGS. 3-5, data fields which are related may be chunked together by placing them in the visible chunking input area.

The chunking rules in the memory 116 may further include rules grouping data fields based upon a flow in space. For example, an origin data field, a destination data field and an alternate data field may be chunked together via a rule grouping data fields based upon a flow in space. Another exemplary rule may group together data fields which are sub-attributes of the same realization. For example, a wind direction data field, a wind speed data field and a wind gust data field may be chunked together as sub-realization rule based upon the realization of wind. Another rule may group data fields based upon variables which combine together to create a new construct. For example, a barometric setting (baro set), pressure altitude and outside air temperature can be combined to construct a density altitude. Another rule may group data fields based upon a flow in time. For example, if the touch screen display 112 is displaying a landing checklist, data fields for flaps and vref may related, and thus displayed together. As another example of a flow in time rule, when a pre-flight checklist is being displayed, chucks of graphics for a synoptic page may be displayed within a certain checklist section. Another rule may be based upon components of a calculation. For example, a fuel weight, a number of passengers, a passenger weight and a location of weight may all be data fields related to a gross weight and balance of the aircraft calculation. As another example, data fields for wind direction, wind speed, wind altitude and aircraft speed may be chunked together via a rule for calculating optimal lateral flight path and vertical plan.

The chunking rules may also be used to indicate when a task is “finished to the brain” and/or “finished to the system.” For example, when an action on a cognitively logical chunk is complete, the processor 114 may close a chunk of related data fields purposefully to indicate the complete step. In other words, the user input interface 300 may automatically close when user input is received to all of the related data fields, or a subset of the related data fields when less then all of the related data fields require input in a given step. This strategy might also be used in, for example, a flight deck to bring together several systems to aid error mitigation. For example, a chunk of data fields may be related to a task, such setting a vertical altitude constraint on a waypoint. When a user sets the vertical altitude constraint and closes the dialog box, it may feel to the user as if they have completed the task, but there may be other remaining tasks if the user wants the aircraft to descend: Arm VNAV, and reset the altitude selector. Here the chunking rules might relate the constraint chunk from the Cross Dialog box, the Arm VNAV chunk from FMS/AFCS, and the Set ASEL chunk from AFCS, and only then, “close” the user input interface 300 when all of the related data fields for the task have been completed.

Accordingly, when a data field on the touch screen display 112 is selected, the processor 114 evaluates one or more rules in the database stored in the memory 116 to determine which other data fields are related to the selected data field. The various rules may be dependent upon a phase of flight. For example, a data field may be related to two chunks of data fields depending upon the whether the aircraft is in, for example, a take-off phase or a cruising phase. In an off-roading vehicle, as an example in a non-aircraft embodiment, data fields which are related may depend upon whether the vehicle is on a road or off-road. For example, when the vehicle is on a highway few input configuration settings may be needed, or even related. In contrast, when the vehicle is off-road, related settings could include tire-pressure adjustments, transfer case settings, sway bar settings, locker settings, brake settings and the like.

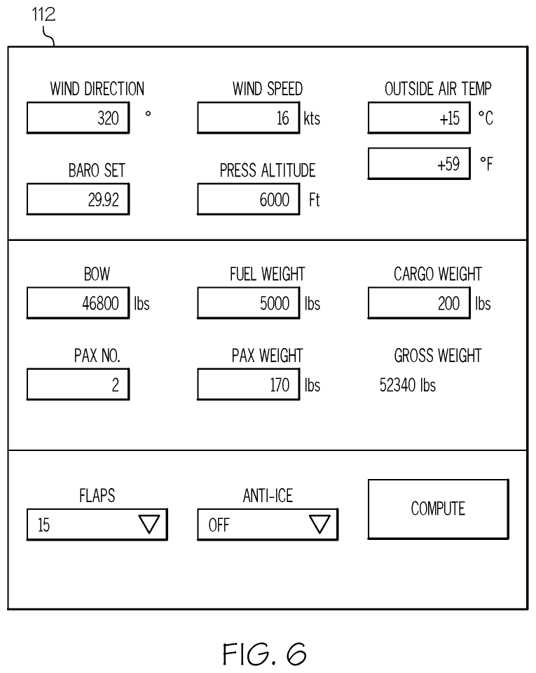

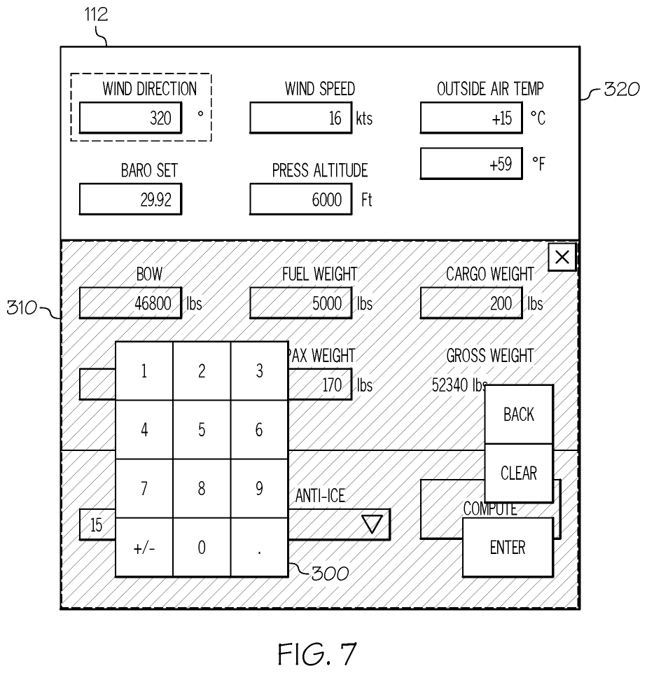

FIG. 6 illustrates an exemplary touch screen display 112, in accordance with an embodiment. The touch screen display 112 includes thirteen data fields which may be useful for an aircraft display. In this exemplary embodiment, a chunking rule may define wind direction and wind speed as data fields which are related. Accordingly, when a user selects, for example, the wind direction data field, the processor 114 displays the related chunked fields. FIG. 7 illustrates an exemplary touch screen display 112, in accordance with an embodiment. As seen in FIG. 7, the wind direction data field is highlighted, in this example with a border around the data field, and the related data field wind speed is also visually represented in the contextual awareness display area 320. In this exemplary embodiment, other non-related data fields, namely barometric setting, pressure altitude and outside air temperature are also visible in the contextual awareness display area 320. In this exemplary embodiment, the portion 310 of the display where the user input interface 300 is located may have a minimum size to display the input interface in a certain configuration. Accordingly, when there is additional display area in the touch screen display 112 to display more than the minimum number of data fields while maintaining the minimum display area for the user interface, the processor 114 may optionally choose to display the additional non-related data fields as is illustrated in FIG. 7.

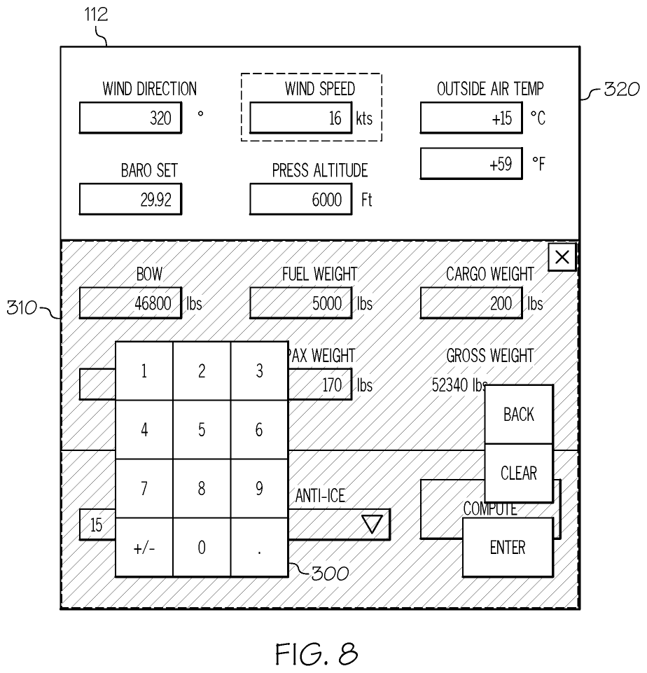

As discussed above, certain data fields may be related with respect to a task. In other words, both fields may be needed to be filled, selected, or otherwise interacted with to complete the task. Accordingly, when a first data field is interacted with, the next data field may automatically be selected by the processor 114 to indicate the next step in the task. Using the interfaces of FIGS. 6 and 7 as an example, when the wind direction data field is selected, the user may use the user input interface 300 to enter a new value in the wind direction data field. When the user has completed interacting with the selected data field, the processor 114 automatically selects the next related data field according to the respective the chunking rule. FIG. 8 illustrates an exemplary touch screen display 112, in accordance with an embodiment. As seen in FIG. 8, the next related data field, in this case wind speed, was automatically selected by the processor 114 when the user completed interacting with the previous data field. As discussed above, once all of the related data fields are interacted with, the user input interface 300 may close. Accordingly, once the user has finished interacting with wind speed, as the wind speed is the last related data field in this example, the processor 114 would return the touch screen display to a standard display mode, such as the one illustrated in FIG. 6.

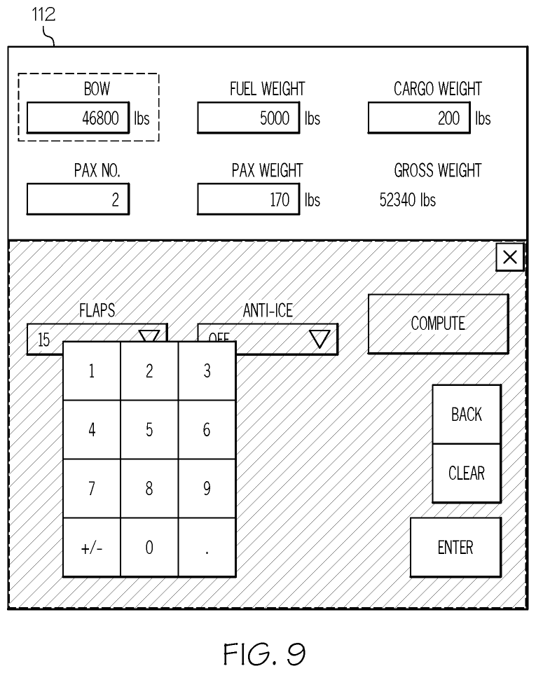

FIG. 9 illustrates an exemplary touch screen display 112 in accordance with an embodiment. In this embodiment, the data field BOW was selected. As seen, relative to FIG. 6, the selected data field is in the middle of the screen which was displayed. In order to maintain contextual awareness of where the user is on the screen, the processor 114 may animate the touch screen display 112 to shift the selected chuck up to the top of the usable space, resulting in the exemplary touch screen display 112 illustrated in FIG. 9. Likewise, when the user is finished interacting with the chunk, the processor 114 may animate the screen to lower the data fields in the display to return to their normal positions as seen in FIG. 6. Accordingly, by animating the touch screen display, the user may be provided with another level of contextual awareness of where they are relative to the default view of the touch screen display 112 when inputting data.

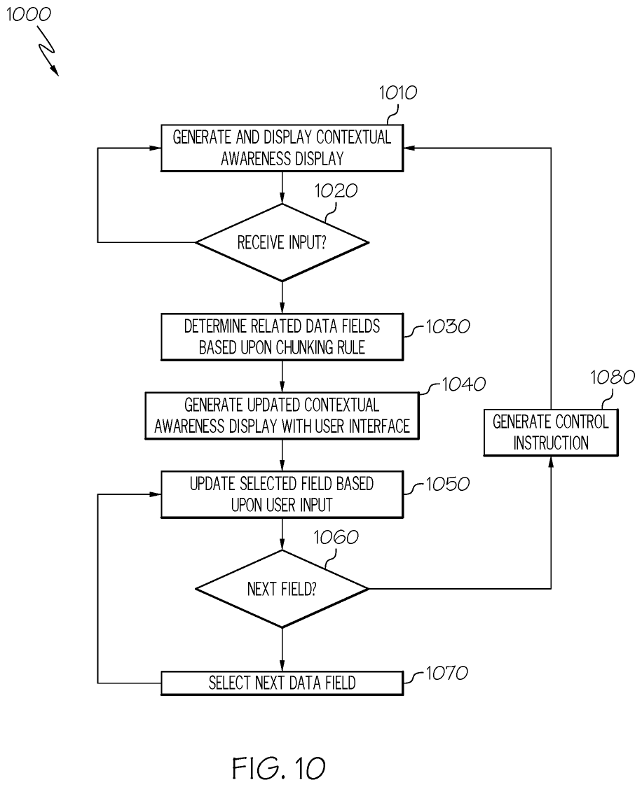

FIG. 10 is a flow diagram illustrating an exemplary method 1000 for operating the contextual awareness system 110, in accordance with an embodiment. The method begins when the processor 114 generates display data for the touch screen display 112 for the contextual awareness system 110 and outputs the display data to the touch screen display 112. (Step 1010). The display data may correspond to, for example, FIGS. 2 and 6 and may be a standard display state of the touch screen display 112 for the contextual awareness system 110 when the user is not interacting with the contextual awareness system 110. In one embodiment, for example, one or more of the data fields displayed on the touch screen display may include data from the data acquisition system 130, such as sensor data and the like.

The processor 114 then monitors the touch screen display 112 for input selected a data field displayed on the touch screen display 112. (Step 1020). The input may be, for example, a user touching a location of the touch screen display corresponding to one of the data fields displayed on the display. While the above description has discussed that the input being a touch on a touch screen display, the input could be from a mouse, a touch pad, a microphone, gesture controls, a track ball, or any other type of user input or any combination thereof. When no input is received, the processor 114 continues to generate the display data as discussed above, including updating any data fields as necessary based upon input from the data acquisition system 130.

When user input is received selecting one of the data fields displayed on the touch screen display 112, the processor 114 analyzes the chunking rules stored in the memory to determine which other data fields are related to the selected data field. (Step 1030). As discussed above, the selected data field may be related to different data fields depending upon a phase of flight of the aircraft. In one embodiment, for example, the memory 116 may store a look-up table which stores related data fields upon a phase of flight, or any other category related to the subject vehicle. However, the chunking rules may be organized in any manner.

The processor 114 then generates updated contextual awareness display data based upon the determined related data fields. (Step 1040). The updated contextual awareness display data includes the user input interface 300 and the contextual awareness display area 320. As discussed above, the user input interface 300 may include a virtual keyboard. The size and format of the keyboard may vary depending upon the size of the contextual awareness display area 320, which is dependent upon the number of related data fields to the selected data field. The contextual awareness display area 320 includes the selected data field and the related data fields. As discussed above, when the number of related data fields exceeds the available space on the touch screen display, the updated contextual awareness display data may include controls to scroll through the related data fields or may automatically scroll through the data fields.

The processor 114, upon receiving input for the selected data field, may then update the selected data field based upon the user input. (Step 1050). The update may include, for example, updating the display data to reflect the new value and, if applicable, sending the update to any aircraft system which utilizes the selected data field. For example, the processor 114 may send the updated value for the data field to an FMS.

When there is a task associated with the selected data field based upon the chunking rule associated with the selected data field (Step 1060), the processor 114 may optionally automatically select the next data field in the task. (Step 1070). The user may then update the newly selected data field as discussed in step 1050. The process may be repeated until all of the tasks associated with the selected data field are complete.

When there is no task associated with the selected data field, or none remaining, the processor 114, or a processor associated with another aircraft system such as an FMS, may generate control instructions based upon the updated data field(s). (Step 1080). The control instructions may be, for example, an update to a flight plan for the aircraft 100, change an altitude of the aircraft 100, change a direction of the aircraft 100, a landing speed computation, which is dependent upon density altitude, may be used to set different braking intensities in an autobrake system, or the like. The processor 114 then returns to Step 1010 and generates updated contextual awareness display data which closes the virtual keyboard and returns the touch screen display to the default state.

Accordingly, the contextual awareness system 110 provides an input system to the aircraft 100 which provides contextual awareness for the input, thereby eliminating the need for a user to navigate between multiple screens to evaluate all of the related data. One benefit for the contextual awareness system 110, in addition to providing contextual awareness for an input, is that it simplifies input into a system for the aircraft, and, thus, control of the aircraft 100.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. An aircraft, comprising:
a touch screen display;
a memory configured to store rules defining a relationship between a plurality of data fields; and
a processor communicatively coupled to the touch screen display and the memory, the processor configured to:
determine when a data field displayed on the touch screen display is selected by a user;
determine at least one data field which is related to the selected data field based upon the rules defining the relationship between a plurality of data fields stored in the memory;
generate display data for the touch screen display, the display data comprising a virtual keyboard and a contextual awareness display area, the contextual awareness display area displaying the selected field and the at least one data field which is related to the selected data; and
update the selected data field based upon input from the virtual keyboard.

2. The aircraft of claim 1, further comprising:
a control system communicatively coupled to the processor, the control system configured to control operation of the aircraft based upon the updated selected field.

3. The aircraft of claim 1, wherein the at least one data field which is related to the selected data field varies depending upon a phase of flight of the aircraft.

4. The aircraft of claim 1, wherein when rules further define a task associated with the selected data field, the task requiring user input for at least two of the plurality of data fields.

5. The aircraft of claim 4, wherein the processor is further configured to automatically select a next data field associated with the task when the selected data field is updated based upon input from the virtual keyboard.

6. The aircraft of claim 1, wherein a background around the virtual keyboard is at least partially transparent.

7. The aircraft of claim 1, where a size of the contextual awareness display area varies depending upon a number of data fields determined to be related to the selected data field.

8. The aircraft of claim 7, where a format of the virtual keyboard varies depending upon the size of the contextual awareness display area.

9. The aircraft of claim 1, wherein the generate display data causes the determined at least data field which is related to the selected data field to scroll across the contextual awareness display area when a number of the determined at least data field which is related to the selected data field is greater than a predetermined threshold.

10. The aircraft of claim 1, wherein the at least one data field which is related to the selected data field is not displayed on the touch screen display prior to the selected data field being selected.

11. A method of operating a contextual awareness system for an aircraft, comprising:
generating, by a processor, contextual awareness display data for the contextual awareness system and outputting the contextual awareness display data to a touch screen display, the contextual awareness display data comprising a plurality of data fields;
receiving, by the processor, input selecting one of the plurality of data fields from the touch screen display;
determining, by the processor, at least one related data field to the selected one of the plurality of data fields based upon a chunking rule associated with the selected one of the plurality of data fields;
generating, by the processor, updated contextual awareness display data for the contextual awareness system and outputting the updated contextual awareness display data to the touch screen display, the updated contextual awareness display data comprising a virtual keyboard and a contextual awareness display area, the contextual awareness display area displaying the selected one of the plurality of data fields and the at least related data field to the selected one of the plurality of data field; and
updating the selected data field based upon input to the virtual keyboard.

12. The method of claim 11, further comprising controlling, by a control system communicatively coupled to the processor, an operation of the aircraft based upon the updated selected field.

13. The method of claim 11, wherein the at least one related data field to the selected one of the plurality of data fields varies depending upon a phase of flight of the aircraft.

14. The method of claim 11, wherein when chunking rule further defines a task associated with the selected one of the plurality of data fields, the task requiring user input for at least two of the plurality of data fields.

15. The method of claim 14, further comprising automatically selecting a next data field associated with the task when the selected one of the plurality of data fields is updated based upon input from the virtual keyboard.

16. The method of claim 11, wherein a background around the virtual keyboard is at least partially transparent.

17. The method of claim 11, where a size of the contextual awareness display area varies depending upon a number of related data fields determined to the selected one of the plurality of data fields.

18. The method of claim 17, where a format of the virtual keyboard varies depending upon the size of the contextual awareness display area.

19. The method of claim 11, wherein the updated contextual awareness display data causes the at least one related data field to the selected one of the plurality of data fields to scroll across the contextual awareness display area when a number of the related data field to the selected one of the plurality of data fields is greater than a predetermined threshold.

20. The method of claim 11, wherein at least one related data field to the selected one of the plurality of data fields is not displayed on the touch screen display prior to the selected one of the plurality of data fields being selected.
